(19) United States
(12) Patent Application Publication
(10) Pub. No.: US 2004/0265517 A1
(43) Pub. Date: Dec. 30, 2004

(54) Thermal transfer recording medium

(76) Inventors: Jun Sogabe, Osaka-shi (JP); Kosaburo Goto, Osaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/879,068

(22) Filed: Jun. 30, 2004

(30) Foreign Application Priority Data
Jun. 30, 2003 (JP) 2003-186377

(51) Int. Cl. B32B 5/30

(52) U.S. Cl. 428/32.61

(57) ABSTRACT

A thermal transfer recording medium comprising a support and a colored layer provided on the support, the colored layer comprising 10 to 30% by weight of a terpene-phenol resin having a softening point of 130° to 160° C. and 10 to 30% by weight of a resin which is substantially incapable of being dissolved in an alcohol and has a softening point of 130° to 180° C.

### BACKGROUND OF THE INVENTION

The present invention relates to a thermal transfer recording medium for printing images such as letters, bar codes and pictures on a variety of films, cards, CD-R, etc. by a thermal transfer method. More particularly, the present invention relates to a thermal transfer recording medium capable of providing images having satisfactory durability such as hot water resistance and alcohol resistance.

In the field of packaging for foods and the like, the use-by date, production date or bar code was hitherto printed on the packaging material by means of a hot-press machine using a transfer leaf. However, these dates are changed every day and the numerical stamps in the hot-press machine have to be reset each time. In some production sites, the production line has to be stopped, resulting in reduction of production efficiency. In order to overcome this problem, a thermal transfer method wherein images are printed on a packaging material by using a thermal transfer printer equipped with a thermal head and a thermal transfer recording medium has been developed. According to this method, images such as dates can be printed on demand without resetting the numerical stamps and, therefore, it is not required to stop the production line.

In the case of a packaging good wherein a food is packaged in a packaging material, there is a case that the date is printed on the packaging material by means of a thermal transfer printer and the packaging goods are then dipped into boiling water at 100° C. and agitated to sterilize the food. In this case, a problem occurs that the image printed on the packaging material is rubbed off due to that the packaging goods are rubbed together. Further, it is conducted to remove the stain attached to the packaging material with a cloth impregnated with an alcohol such as ethyl alcohol. In this case, the image printed on the packaging material is also sometimes rubbed off. In order to overcome these problems, a thermal transfer recording medium capable of providing images having satisfactory wear resistance and alcohol resistance as disclosed in patent document 1 among various thermal transfer recording media has been used. However, this thermal transfer recording medium does not also comply with wear resistance in boiling water at 100° C. (hereinafter referred to as “hot water resistance”) required for the image printed on the packaging material of the above-mentioned packaged food due to that the image is rubbed off. Patent document 1: JP, A, 5-177954

In view of the foregoing, it is an object of the present invention to provide a thermal transfer recording material having satisfactory thermal transferability to various films for packaging material, cards, CD-R, etc. and capable of providing an image having satisfactory hot water resistance and alcohol resistance.

### SUMMARY OF THE INVENTION

The present invention provides the following thermal transfer recording media.

(1) A thermal transfer recording medium comprising a support and a colored layer provided on the support, the colored layer comprising 10 to 30% by weight of a terpene-phenol resin having a softening point of 130° to 160° C. and 10 to 30% by weight of a resin which is substantially incapable of being dissolved in an alcohol and has a softening point of 130° to 180° C.

(2) The thermal transfer recording medium of (1) above, wherein the resin which is substantially incapable of being dissolved in an alcohol comprises at least one selected from alicyclic saturated hydrocarbon resins and acrylic resins.

(3) The thermal transfer recording medium of (1) or (2) above, which further comprises a release layer between the support and the colored layer, the release layer comprising a polyethylene wax having a melting point of 90° to 150° C. as a main component by weight.

### DETAILED DESCRIPTION

The thermal transfer recording medium of the present invention has a fundamental structure wherein a colored layer is provided on a support.

As the support used in the present invention, any web-like materials as supports for conventional thermal transfer recording media can be used. In terms of durability, heat transmittance and cost, a polyethylene terephthalate (PET) film with a thickness of 1 to 6 μm having a heat-resistant layer on the back side is preferably used.

The colored layer, which is a characteristic element of the present invention, contains a coloring agent, 10 to 30% by weight of a terpene-phenol resin having a softening point of 130° to 160° C. and 10 to 30% by weight of a resin which is substantially incapable of being dissolved in an alcohol and has a softening point of 130° to 180° C. The softening point in the present invention is intended to mean a value measured with a ring and ball method. The resin which is substantially incapable of being dissolved in an alcohol is sometimes referred to as “resin insoluble in an alcohol”.

When the softening point of the terpene-phenol resin is lower than the above range, satisfactory hot water resistance is not obtained. When the softening point of the terpene-phenol resin is higher than the above range, the thermal sensitivity is lowered. When the softening point of the resin insoluble in an alcohol is lower than the above range, satisfactory hot water resistance is not obtained. When the softening point of the resin insoluble in an alcohol is higher than the above range, the thermal sensitivity is lowered. When the content of the terpene-phenol resin is less than the above range, the adhesion of image tends to be degraded. When the content of the terpene-phenol resin is more than the above range, the alcohol resistance tends to be degraded. When the content of the resin insoluble in an alcohol is less than the above range, satisfactory alcohol resistance is not obtained. When the content of the resin insoluble in an alcohol is more than the above range, the transfer sensitivity tends to be lowered.

The terpene-phenol resins useful in the present invention can be obtained from at least one selected from terpenes such as α-pinene, β-pinene and diterpene, and at least one selected from phenols such as phenol, cresol, xylenol, propylphenol, nonylphenol, bromophenol, hydroquinone, resorcinol, naphthol and dihydroxynaphthol according to a polymerization method such as solution polymerization. Typical examples of commercially available terpene-phenol resins include YS Polyster 2000, YS Polyster U, T, S (all made by Yasuhara Chemical Co., Ltd.).

Examples of the resins insoluble in an alcohol include alicyclic saturated hydrocarbon resins, acrylic resins, polyester resins, vinyl chloride/vinyl acetate copolymer resins, and the like. These resins may be used alone or in combinations of two or more species. At least one selected from alicyclic saturated hydrocarbon resins and acrylic resins is preferred since images with high definition can be obtained. The alicyclic saturated hydrocarbon resins usable in the present invention can be obtained by hydrogenation of polymers prepared by thermal polymerization of cyclopentadiene or dicyclopentadiene, or by hydrogenation of aromatic petroleum resins at high temperature under high pressure. Examples of the acrylic resins usable in the present invention are acrylic acid resin, methacrylic acid resin, alkyl acrylate resins, alkyl methacrylate resins, acrylonitrile resin, and acrylonitrile-styrene resin. The alkyl groups in the alkyl acrylate resins and alkyl methacrylate resins are, for instance, those having 1 to 25 carbon atoms such as methyl, ethyl, propyl, isopropyl, butyl, amyl, octyl and stearyl.

If desired in terms of improving the transfer sensitivity and the like, the colored layer may be incorporated with a wax. As the wax, hard waxes having a penetration of 1 or less, such as carnauba wax and polyethylene wax, are preferably used.

Further, the colored layer may be incorporated with at least one of other thermoplastic resins besides the above-mentioned binder components without injuring the desired results of the present invention. Examples of these resins are ethylene/vinyl acetate copolymer resin (EVA), ethylene/ethyl acrylate copolymer resin (EEA), urethane resins, polyamide resins, and chlorinated polypropylene.

As the coloring agent, any conventional various pigments and dyes can be used. Examples of the pigments include azo pigments, phthalocyanine pigments, quinacridone pigments, thioindigo pigments, anthraquinone pigments, isoindoline pigments, carbon black, and the like. These coloring agents can be used alone or in combination of two or more species.

Further, the colored layer may be incorporated with lubricating agents such as particulating materials (e.g. silica), silicone oil, and fluorine-containing surface active agent in terms of preventing blocking and stain.

The coating amount of the colored layer is preferably from 0.5 to 1.5 g/m² on a solid basis after drying.

In the present invention, it is possible to further improve adhesion of the colored layer against an image receptor such as packaging material and transfer sensitivity by providing a release layer between the support and the colored layer. The release layer in the present invention comprises a polyethylene wax having a melting point of 90° to 150° C. as a main component. The content of the polyethylene wax having a melting point of 90° to 150° C. in the release layer is preferably not less than 50% by weight. By using such a release layer, it is possible to improve the transfer sensitivity with maintaining the desired performance of the colored layer. If necessary, the release layer may be incorporated with a thermoplastic resin. Examples of the thermoplastic resin are those recited for the colored layer. The coating amount of the release layer is preferably from 0.15 to 1.50 g/m² on a solid basis after drying in terms of transfer sensitivity.

As the image receptor on which an image is preferably printed by using the thermal transfer recording medium of the present invention, various films for use in packaging material are used. Examples of the films include biaxially stretched polypropylene film (OPP film), nonstretched polypropylene film (CPP film), polyester films, polyethylene film, aluminum-deposited films, and composite films of the foregoing. It is also possible to print an image on cards made of a resin and optical disks such as CD-R by using the thermal transfer recording medium of the present invention and the obtained images have excellent hot water resistance, wear resistance and alcohol resistance. Further, it is possible to print an image on coated paper wherein a paper base is coated with a resin layer like the resin card by using the thermal transfer recording medium of the present invention and the obtained images have the same excellent properties as those obtained on the resin cards.

The formation of the colored layer and release layer on the support can be performed by applying and drying respective coating liquids by means of conventional coater.

The present invention will be more fully described by way of the following Examples. However, the scope of the present invention is not limited to the Examples.

### EXAMPLES 1 to 2 AND COMPARATIVE EXAMPLES 1 to 3

A 4.5 μm-thick PET film having a heat-resistant layer having a thickness of 0.2 μm on the back side was used as a support. The coating liquid for release layer having the following composition was applied onto the support by means of a gravure coater and dried. The coating amount was 0.7 g/m² on a solid basis after drying.

| Coating liquid for release layer | Parts by weight |
|---|---|
| Polyethylene wax (m.p. 107° C.) | 5.5 |
| α-Olefin wax (m.p. 80° C.) | 0.8 |
| EVA | 1.2 |
| Toluene | 45.0 |
| Isopropyl alcohol | 47.5 |
| Total | 100.0 |

Each coating liquid for colored layer having the composition shown in Table 1 was applied onto the release layer by means of a gravure coater and dried, giving a thermal transfer recording medium. The coating amount of the colored layer was 1.0 g/m² on a solid basis after drying.

TABLE 1

| | | | Com. | Com. | Com. |
|---|---|---|---|---|---|
| Component | Ex. 1 | Ex. 2 | Ex. 1 | Ex. 2 | Ex. 3 |
| Terpene-phenol resin | 5 | 5 | | 10 | |
| (softening point: 135° C.) | | | | | |
| Terpene-phenol resin | | | 5 | | |
| (softening point: 100° C.) | | | | | |
| Alicyclic saturated hydrocarbon | 5 | | | | |
| resin (softening point: 140° C.) | | | | | |
| Alicyclic saturated hydrocarbon | | | 5 | | |
| resin (softening point: 75° C.) | | | | | |
| Acrylic resin | | 5 | | | |
| (softening point: 150° C.) | | | | | |
| Styrene resin | | | | | 10 |
| (softening point: 80° C.) | | | | | |
| Carnauba wax | 4 | 4 | 4 | 4 | 4 |
| Carbon black | 5.5 | 5.5 | 5.5 | 5.5 | 5.5 |
| Dispersing agent | 0.5 | 0.5 | 0.5 | 0.5 | 0.5 |
| Toluene | 80 | 80 | 80 | 80 | 80 |

Amount of each component: parts by weight Softening point: measured by the ring and ball method provided JIS K 2207(6.4)

With respect to the obtained thermal transfer recording media, the following characteristic properties were evaluated.

(1) Transferability to Films for Packaging

An image was printed on the following film for packaging under the following printing conditions.

Film: 25 μm-thick OPP film and 25 μm-thick PET film

Printer for packaging material: Jaguar printer (made by Compura)

Printing energy: 95%

Printing speed: 100 mm/second

Printing pattern: bar code

Criteria

∘: Satisfactorily transferred image is obtained.

Δ: Image with dropout portion is obtained.

X: The transfer fails absolutely.

(2) Alcohol Resistance

A cloth impregnated with ethyl alcohol was moved to and fro ten times on the image (on the OPP film) obtained in (1) above under a load of 4.9 N/cm².

Criteria

∘: No substantial change is observed in the image.

Δ: A slight part of the image falls off.

X: The image falls off markedly and is soiled markedly.

(3) Hot Water Resistance

A cloth was moved to and fro ten times on the image (on the OPP film) obtained in (1) above under a load of 4.9 N/cm² in boiling water at 100° C.

Criteria

∘: No substantial change is observed in the image.

Δ: A slight part of the image falls off.

X: The image falls off markedly and is soiled markedly.

The results obtained above are shown in Table 2.

TABLE 2

| | | | Com. | Com. | Com. |
|---|---|---|---|---|---|
| Evaluation item | Ex. 1 | Ex. 2 | Ex. 1 | Ex. 2 | Ex. 3 |
| Transferability | | | | | |
| OPP film | ◯ | ◯ | Δ | ◯ | X |
| PET film | ◯ | ◯ | Δ | ◯ | Δ |
| Alcohol resistance | ◯ | ◯ | Δ | X | Δ |
| Hot water resistance | ◯ | ◯ | X | ◯ | X |

As shown in Table 2, the images obtained in Examples 1 and 2 satisfied all evaluation items but none of the images obtained in Comparative Examples 1 to 3 satisfied all evaluation items.

What is claimed is:

1. A thermal transfer recording medium comprising a support and a colored layer provided on the support, the colored layer comprising 10 to 30% by weight of a terpene-phenol resin having a softening point of 130° to 160° C. and 10 to 30% by weight of a resin which is substantially incapable of being dissolved in an alcohol and has a softening point of 130° to 180° C.

2. The thermal transfer recording medium of claim 1, wherein the resin which is substantially incapable of being dissolved in an alcohol comprises at least one selected from alicyclic saturated hydrocarbon resins and acrylic resins.

3. The thermal transfer recording medium of claim 1, which further comprises a release layer between the support and the colored layer, the release layer comprising a polyethylene wax having a melting point of 90° to 150° C. as a main component by weight.
